(19) United States
(12) Patent Application Publication
(10) Pub. No.: US 2020/0310776 A1
(43) Pub. Date: Oct. 1, 2020

(54) OVER-THE-AIR UPDATE VALIDATION

(71) Applicant: Micron Technology, Inc., Boise, ID (US)

(72) Inventors: Alberto Troia, Munich (DE); Antonino Mondello, Messina (IT)

(21) Appl. No.: 16/362,790

(22) Filed: Mar. 25, 2019

(51) Int. Cl. G06F 8/65; H04W 12/04; H04W 12/12; H04W 12/06; H04L 9/32

(52) U.S. Cl. CPC G06F 8/65; H04W 12/04071; H04W 12/0401; H04L 2209/80; H04W 12/06; H04L 9/3247; H04W 12/1204

(57) ABSTRACT

The present disclosure includes apparatuses, methods, and systems for over-the-air update validation. An embodiment includes a memory, and circuitry associated with the memory, where the circuitry is configured to monitor the memory for receipt of over-the-air updates, store a received update in a secure array of the memory, receive a hash of a signature associated with the received update and store the hash of the received signature in a register of the memory, receive an indication that the received update is authentic, wherein the indication includes a hash of an expected signature, and take an action in response to the indication that the received update is authentic.

### TECHNICAL FIELD

The present disclosure relates generally to semiconductor memory and methods, and more particularly, to using memory to validate over-the-air updates.

### BACKGROUND

Memory devices are typically provided as internal, semiconductor, integrated circuits and/or external removable devices in computers or other electronic devices. There are many different types of memory including volatile and non-volatile memory. Volatile memory can require power to maintain its data and can include random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), and resistance variable memory such as phase change random access memory (PCRAM), resistive random access memory (RRAM), and magnetic random access memory (MRAM), among others.

Memory devices can be combined together to form a solid state drive (SSD), an embedded MultiMediaCard (e.MMC), and/or a universal flash storage (UFS) device. An SSD, e.MMC, and/or UFS device can include non-volatile memory (e.g., NAND flash memory and/or NOR flash memory), and/or can include volatile memory (e.g., DRAM and/or SDRAM), among various other types of non-volatile and volatile memory. Non-volatile memory may be used in a wide range of electronic applications such as personal computers, portable memory sticks, digital cameras, cellular telephones, portable music players such as MP3 players, movie players, among others.

Flash memory devices can include memory cells storing data in a charge storage structure such as a floating gate, for instance. Flash memory devices typically use a one-transistor memory cell that allows for high memory densities, high reliability, and low power consumption. Resistance variable memory devices can include resistive memory cells that can store data based on the resistance state of a storage element (e.g., a resistive memory element having a variable resistance).

Memory cells can be arranged into arrays, and memory cells in an array architecture can be programmed to a target (e.g., desired) state. For instance, electric charge can be placed on or removed from the charge storage structure (e.g., floating gate) of a flash memory cell to program the cell to a particular data state. The stored charge on the charge storage structure of the cell can indicate a threshold voltage (Vt) of the cell. A state of a flash memory cell can be determined by sensing the stored charge on the charge storage structure (e.g., the Vt) of the cell.

Many threats can affect the data stored in the memory cells of a memory device. Such threats can include, for example, faults occurring in the memory device, and/or threats from hackers or other malicious users. Such threats can cause significant financial loss, and/or can present significant safety and/or security issues.

### BRIEF DESCRIPTION OF THE DRAWINGS

FIG. 1 illustrates a diagram of a portion of a memory array having a number of physical blocks in accordance with an embodiment of the present disclosure.

FIG. 2 is a block diagram of a computing system including a host and an apparatus in the form of a memory device in accordance with an embodiment of the present disclosure.

FIG. 3 illustrates an example system for over-the-air update validation using an example memory device in accordance with an embodiment of the present disclosure.

FIG. 4 illustrates an example flow diagram for over-the-air update validation using an example memory device in accordance with an embodiment of the present disclosure.

FIG. 5A illustrates an example of a pair of registers used to define a secure memory array in accordance with an embodiment of the present disclosure.

FIG. 5B illustrates a diagram of a portion of a memory array that includes a secure memory array defined in accordance with an embodiment of the present disclosure.

FIG. 6 is a block diagram of an example system including a host and a memory device in accordance with an embodiment of the present disclosure.

FIG. 7 is a block diagram of an example process to determine a number of parameters in accordance with an embodiment of the present disclosure.

FIG. 8 is a block diagram of an example process to determine a number of parameters in accordance with an embodiment of the present disclosure.

FIG. 9 is a block diagram of an example process to verify a certificate in accordance with an embodiment of the present disclosure.

FIG. 10 is a block diagram of an example process to verify a signature in accordance with an embodiment of the present disclosure.

FIG. 11 is a block diagram of an example memory device in accordance with an embodiment of the present disclosure.

### DETAILED DESCRIPTION

The present disclosure includes apparatuses, methods, and systems for using memory to validate over-the-air updates. An embodiment includes a memory, and circuitry configured to monitor a memory device for over-the-air updates for validation. The updates may be received by the memory device from a host device, where the host device is transmitting updates over-the-air intended for devices monitored by the host device. For example, a host device may be a server monitoring multiple devices in a network environment. The server may propagate updates to the monitored devices when the monitored devices require updates. As over-the-air update can transmit the updates wirelessly using a wireless computing network. The updates include data (e.g., transactions, software updates, hardware updates, or data that would otherwise modify software, hardware, code, firmware, or portions of code, etc.).

The memory device may be associated with an individual host or multiple hosts. Each host may be monitoring an individual device or multiple devices, where each update generated by the host may be associated with an individual device, multiple devices, and/or devices of a particular category or designation (e.g., an update for all devices in a particular geographic location, of a particular device type, device brand, device identification, etc.). In some examples, the devices monitored by the host may not have the memory or computing capabilities to validate the update prior to implementing the update.

Such devices may be Internet of Things (IoT) devices which may require updates, but lack the required controllers, memory, hardware security modules (HSM), etc., to secure and/or validate an update. For example, a host (e.g., a server) may monitor multiple devices and/or device types (e.g., types of devices, brands, etc.) for updates. As used herein a type of device refers to a category and/or grouping of devices based on a device metric, e.g., sensors, computing devices, wearable devices, automotive devices, etc. Some of the devices monitored may be low-cost devices that lack the sophistication of a more complex, high cost, powerful device. For example, a sensor may include IoT capabilities and be monitored by a host (e.g., a server) but lack the components to validate, secure, and/or verify an update for itself. In contrast, higher complexity devices such as computing components for an autonomous vehicle may include HSM components etc. to verify, validate, or otherwise secure updates when they are received. In some examples, the host (e.g., a server) may be associated with a manufacture of the devices (e.g., IoT sensors) and push updates as they are required to various IoT sensors monitored by the server. Because the IoT sensor may lack the sophisticated capabilities to validate the update, the server may utilize an external boot memory device and circuitry to store the update in a secure memory array for validation.

Absent a method to validate an update prior to implementing the update into a device leaves the device and/or the host vulnerable to threats and/or inadvertent changes to the device via an update. Such activities performed by a hacker may include providing a fraudulent updates to software or hardware of a device. For instance, a malicious user may attempt to alter the data stored in firmware via an update in order to adversely affect (e.g., divert the flow of) a commercial transaction being performed using the firmware (e.g., to falsely indicate that payment has been made for the service being provided by skipping the code that verifies the payment), a software license check being performed on the firmware (e.g., to falsely indicate the software of the firmware is properly licensed by skipping the code that verifies the license), or automotive control being performed using the memory (e.g., to skip a check of the genuineness of a part, an environmental check, or a check of a malfunctioning alarm), among other types of hacking activities.

For example, many threats can affect the operation of a device by altering the configuration of the software, hardware, firmware and/or the data stored therein. A hacker or other malicious user may attempt to perform activities (e.g., attacks), to make unauthorized changes to the operation of the device, by changing software, hardware, firmware and/or the data stored therein, for malicious purposes. Changes to the operation of a device may be implemented through updates (e.g., a firmware update) sent to the devices. For example, an update can include instructions to configure an IoT device monitored by a host associated with the memory device. In some examples, a hacking attack may fraudulently propagate an update to a device acting as though they are the authorized host. Such hacking activities can cause significant financial loss, and/or can present significant safety and/or security issues.

As such, in order to ensure a secure update to a device, it is important to validate (e.g., authenticate and/or attest) that the update to the data (e.g., firmware) stored in the device is genuine (e.g., is the correct, from an authentic/authorized entity), and has not been altered and/or fraudulently provided by hacking activity or other unauthorized and/or unintended changes.

Example embodiments herein, describe systems, apparatuses, and methods to use memory to validate that an update is from an authorized host, and that the update received is has not been altered or intercepted. Memory and circuitry associated with the host can receive the update, and a signature corresponding to the update, to verify that the update is from a host associated with the device to be updated. The memory device can validate the update for the device monitored by the host by comparing an expected signature to the received signature.

Once validated, the memory device can make the update available to the device to be updated by coping the verified update to a different portion of the memory array. Using this method, the device may receive a validated update from the host via an external memory device, without the requirement of possessing sophisticated computing power. For instance, embodiments of the present disclosure can modify, utilize, and/or differently operate the existing circuitry of the memory (e.g., the existing firmware of the external memory device) to use the memory as over-the-air update validation device without having to add additional (e.g., new) components or circuitry to the memory.

As used herein, “a”, “an”, or “a number of” can refer to one or more of something, and “a plurality of” can refer to two or more such things. For example, a memory device can refer to one or more memory devices, and a plurality of memory devices can refer to two or more memory devices. Additionally, the designators “R”, “B”, “S”, and “N”, as used herein, particularly with respect to reference numerals in the drawings, indicates that a number of the particular feature so designated can be included with a number of embodiments of the present disclosure. The number may be the same or different between designations.

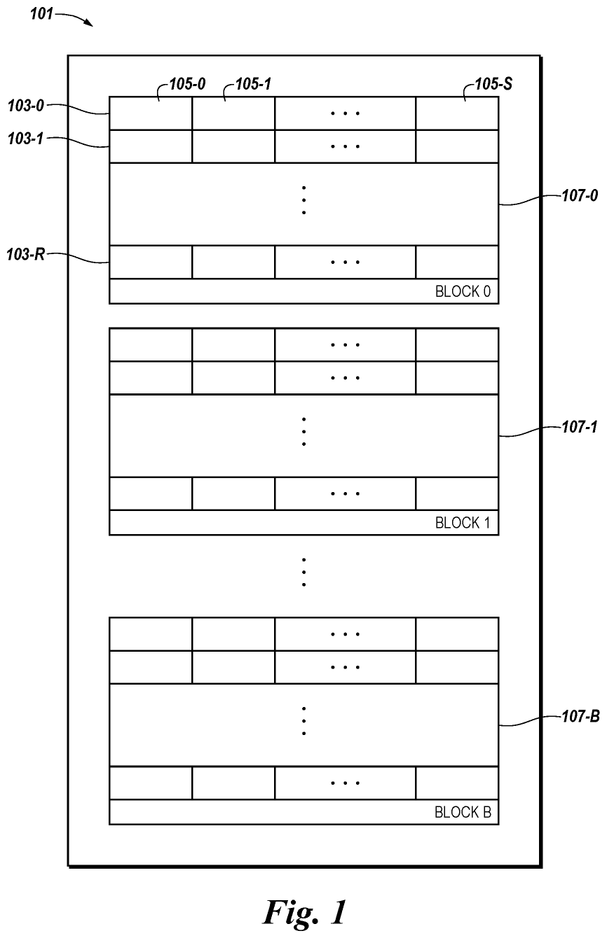

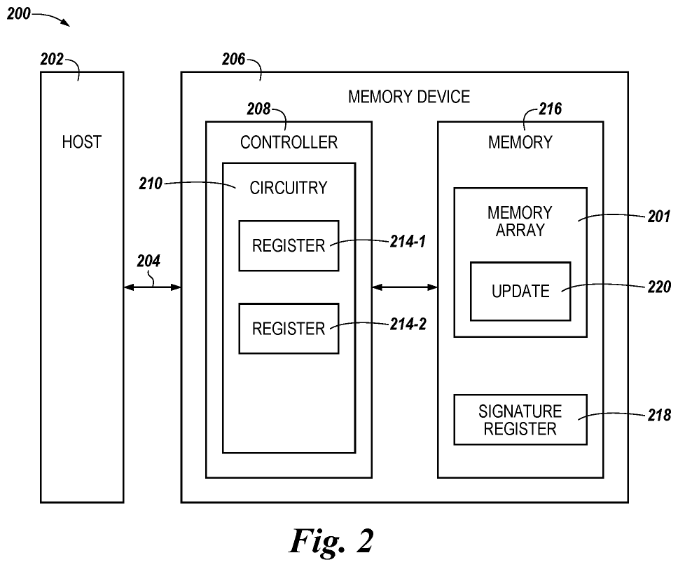

The figures herein follow a numbering convention in which the first digit or digits correspond to the drawing figure number and the remaining digits identify an element or component in the drawing. Similar elements or components between different figures may be identified by the use of similar digits. For example, 101 may reference element “01” in FIG. 1, and a similar element may be referenced as 201 in FIG. 2.

FIG. 1 illustrates a diagram of a portion of a memory array 101 having a number of physical blocks in accordance with an embodiment of the present disclosure. Memory array 101 can be, for example, a flash memory array such as a NAND, and/or NOR flash memory array. In one example embodiment, the memory 101 is a NOR flash memory array 101. As an additional example, memory array 101 can be a resistance variable memory array such as a PCRAM, RRAM, MMRAM, or spin torque transfer (STT) array, among others. However, embodiments of the present disclosure are not limited to a particular type of memory array. Further, memory array 101 can be a secure memory array, as will be further described herein. Further, although not shown in FIG. 1, memory array 101 can be located on a particular semiconductor die along with various peripheral circuitry associated with the operation thereof.

As shown in FIG. 1, memory array 101 has a number of physical blocks 107-0 (BLOCK 0), 107-1 (BLOCK 1), . . . , 107-B (BLOCK B) of memory cells. The memory cells can be single level cells and/or multilevel cells such as, for instance, two level cells, triple level cells (TLCs) or quadruple level cells (QLCs). As an example, the number of physical blocks in memory array 101 may be 128 blocks, 512 blocks, or 1,024 blocks, but embodiments are not limited to a particular power of two or to any particular number of physical blocks in memory array 101.

A number of physical blocks of memory cells (e.g., blocks 107-0, 107-1, . . . , 107-B) can be included in a plane of memory cells, and a number of planes of memory cells can be included on a die. For instance, in the example shown in FIG. 1, each physical block 107-0, 107-1, . . . , 107-B can be part of a single die. That is, the portion of memory array 101 illustrated in FIG. 1 can be a die of memory cells.

As shown in FIG. 1, each physical block 107-0, 107-1, . . . , 107-B includes a number of physical rows (e.g., 103-0, 103-1, . . . , 103-R) of memory cells coupled to access lines (e.g., word lines). The number of rows (e.g., word lines) in each physical block can be 32, but embodiments are not limited to a particular number of rows 103-0, 103-1, . . . , 103-R per physical block. Further, although not shown in FIG. 1, the memory cells can be coupled to columns of sense lines (e.g., data lines and/or digit lines).

As one of ordinary skill in the art will appreciate, each row 103-0, 103-1, . . . , 103-R can include a number of pages of memory cells (e.g., physical pages). A physical page refers to a unit of programming and/or sensing (e.g., a number of memory cells that are programmed and/or sensed together as a functional group). In the embodiment shown in FIG. 1, each row 103-0, 103-1, . . . , 103-R comprises one physical page of memory cells. However, embodiments of the present disclosure are not so limited. For instance, in an embodiment, each row can comprise multiple physical pages of memory cells (e.g., one or more even pages of memory cells coupled to even-numbered data lines, and one or more odd pages of memory cells coupled to odd numbered data lines). Additionally, for embodiments including multilevel cells, a physical page of memory cells can store multiple pages (e.g., logical pages) of data (e.g., an upper page of data and a lower page of data, with each cell in a physical page storing one or more bits towards an upper page of data and one or more bits towards a lower page of data).

As shown in FIG. 1, a page of memory cells can comprise a number of physical sectors 105-0, 105-1, . . . , 105-S (e.g., subsets of memory cells). Each physical sector 105-0, 105-1, . . . , 105-S of cells can store a number of logical sectors of data. Additionally, each logical sector of data can correspond to a portion of a particular page of data. As an example, a first logical sector of data stored in a particular physical sector can correspond to a logical sector corresponding to a first page of data, and a second logical sector of data stored in the particular physical sector can correspond to a second page of data. Each physical sector 105-0, 105-1, . . . , 105-S, can store system and/or user data, and/or can include overhead data, such as error correction code (ECC) data, logical block address (LBA) data, and metadata.

Logical block addressing is a scheme that can be used by a host for identifying a logical sector of data. For example, each logical sector can correspond to a unique logical block address (LBA). Additionally, an LBA may also correspond (e.g., dynamically map) to a physical address, such as a physical block address (PBA), that may indicate the physical location of that logical sector of data in the memory. A logical sector of data can be a number of bytes of data (e.g., 256 bytes, 512 bytes, 1,024 bytes, or 4,096 bytes). However, embodiments are not limited to these examples.

It is noted that other configurations for the physical blocks 107-0, 107-1, . . . , 107-B, rows 103-0, 103-1, . . . , 103-R, sectors 105-0, 105-1, . . . , 105-S, and pages are possible. For example, rows 103-0, 103-1, . . . , 103-R of physical blocks 107-0, 107-1, . . . , 107-B can each store data corresponding to a single logical sector which can include, for example, more or less than 512 bytes of data.

FIG. 2 is a block diagram of a computing system 200 including a host 202 and an apparatus in the form of a memory device 206 in accordance with an embodiment of the present disclosure. As used herein, an “apparatus” can refer to, but is not limited to, any of a variety of structures or combinations of structures, such as a circuit or circuitry, a die or dice, a module or modules, a device or devices, or a system or systems, for example. Further, in an embodiment, computing system 200 can include a number of memory devices analogous to memory device 206.

In the embodiment illustrated in FIG. 2, memory device 206 can include a memory 216 having a memory array 201. Memory array 201 can be analogous to memory array 101 previously described in connection with FIG. 1. Further, memory array 201 can be a secure array, as will be further described herein. Although one memory array 201 is illustrated in FIG. 2, memory 216 can include any number of memory arrays analogous to memory array 201.

As illustrated in FIG. 2, host 202 can be coupled to the memory device 206 via interface 204. Host 202 and memory device 206 can communicate (e.g., send commands and/or data) on interface 204. Host 202 and/or memory device 206 can be, or be part of, a laptop computer, personal computer, digital camera, digital recording and playback device, mobile telephone, PDA, memory card reader, interface hub, or Internet of Things (IoT) enabled device, such as, for instance, an automotive (e.g., vehicular and/or transportation infrastructure) IoT enabled device or a medical (e.g., implantable and/or health monitoring) IoT enabled device, among other host systems, and can include a memory access device (e.g., a processor). One of ordinary skill in the art will appreciate that “a processor” can intend one or more processors, such as a parallel processing system, a number of coprocessors, etc.

Interface 204 can be in the form of a standardized physical interface. For example, when memory device 206 is used for information storage in computing system 200, interface 204 can be a serial advanced technology attachment (SATA) physical interface, a peripheral component interconnect express (PCIe) physical interface, a universal serial bus (USB) physical interface, or a small computer system interface (SCSI), among other physical connectors and/or interfaces. In general, however, interface 204 can provide an interface for passing control, address, information (e.g., data), and other signals between memory device 206 and a host (e.g., host 202) having compatible receptors for interface 204.

In other examples, interface 204 can be a non-physical interface. For example, the memory device 206 may be communicatively coupled to the host 202 via a wireless interface as part of a wireless network, and/or a touchless interface absent a physical connection. Some examples of a wireless network are Wireless Local Area Networks (WLAN), Wireless Personal Area Networks (WPANS), Wireless Metropolitan Area Networks (WMANS), and Wireless Wide Area Networks (WWANS). In some examples, the interface 204 may be utilized in a wireless environment when the host 202 is a network device (e.g., a server in a cloud environment). In such examples, the host 202 may propagate updates over-the-air (e.g., wirelessly) to devices monitored by the host 202.

Memory device 206 includes controller 208 to communicate with host 202 and with memory 216 (e.g., memory array 201). For instance, controller 208 can send commands to perform operations on memory array 201, including operations to sense (e.g., read), program (e.g., write), move, and/or erase data, among other operations.

Controller 208 can be included on the same physical device (e.g., the same die) as memory 216. Alternatively, controller 208 can be included on a separate physical device that is communicatively coupled to the physical device that includes memory 216. In an embodiment, components of controller 208 can be spread across multiple physical devices (e.g., some components on the same die as the memory, and some components on a different die, module, or board) as a distributed controller.

Host 202 can include a host controller (not shown FIG. 2) to communicate with memory device 206. The host controller can send commands to memory device 206 via interface 204. The host controller can communicate with memory device 206 and/or the controller 208 on the memory device 206 to read, write, store, and/or erase data, among other operations. Further, in an embodiment, host 202 can be a server, and/or an IoT enabled device, as previously described herein, having IoT communication capabilities.

For example, the host 202 can be a network device (e.g., a server) that monitors individual and/or multiple devices (e.g., IoT devices) within a wireless network and the devices may require updates to firmware and/or other configuration changes. The devices monitored by the host 202 may be unsophisticated, low cost, modest IoT devices (e.g., temperature sensors, etc.) which can lack the capability to validate updates transmitted over-the-air from the host 202. This is in contrast to sophisticated IoT devices (e.g., IoT vehicle computing systems, etc.), which may have the capability to perform validation etc. Further, the host 202 may be a server associated with the manufacture of multiple types of devices. As used herein, validating and/or verifying the update 220 stored in memory array 201 can include, and/or refer to, authenticating and/or attesting that the update is genuine (e.g., is the same as originally programmed and/or received from the associated host), and has not been altered by hacking activity, frequently provided by a hacker, or other including unauthorized/unintended changes.

For example, the host 202 may be a server monitoring different brands of IoT devices, different types of IoT devices (e.g., temperature sensor, pressure sensor, etc.), IoT devices in particular geographical locations, etc. and may push updates to multiple devices over-the-air. Because these IoT devices can lack the capability to provide and/or maintain security of the updates pushed to them by the host 202, the host 202 may be associated with a memory device 206 for validation of the updates.

Controller 208 on memory device 206 and/or the host controller on host 202 can include control circuitry and/or logic (e.g., hardware and firmware). In an embodiment, controller 208 on memory device 206 and/or the host controller on host 202 can be an application specific integrated circuit (ASIC) coupled to a printed circuit board including a physical interface. Also, memory device 206 and/or host 202 can include a buffer of volatile and/or non-volatile memory and a number of registers.

For example, as shown in FIG. 2, memory device 206 can include circuitry 210. In the embodiment illustrated in FIG. 2, circuitry 210 is included in controller 208. However, embodiments of the present disclosure are not so limited. For instance, in an embodiment, circuitry 210 may be included in (e.g., on the same die as) memory 216 (e.g., instead of in controller 208). Circuitry 210 can comprise, for instance, hardware, firmware, and/or communicate instructions to a processing resource.

Circuitry 210 can be configured to monitor the memory device 206 for over-the-air updates received from a host 202 associated with the memory device 206. When an over-the-air update is received by the memory device 206, the circuitry 210 can store the received update 220 in a secure array 201 of the memory 216. The memory 216 may receive a signature associated with the update 220 and store the received signature in a dedicated signature register 218 of the memory 216. The received signature is a hash that is calculated by the host 202 and provided in association with the update 220 (e.g., can be transmitted together with the update 220).

The host 202 may transmit a signal requesting a freshness value from the circuitry 210 and/or the memory 216 to calculate the signature to be used to validate the update 220 and stored in the signature register 218. For example, the circuitry 210 can be configured to provide a freshness value (e.g., from a monotonic counter) when the host 202 generates the signature associated with the update 220.

An example indication that the received update 220 is authentic can be receiving a signature associated with the received update 220, and/or calculating an expected signature of the update 220. For example, the memory 216 having received the signature associated with the update 220 and calculating an expected signature to validate the received signature can be an indication that the received update 220 is authentic. The circuitry 210 may take an action in response to the indication that the update 220 is authentic. For example, an action taken in response to an indication of authenticity can be to further validate the update 220 by comparing the received signature to a recalculated signature (e.g., generating an expected signature). The expected signature can be generated in response to a signal received by the memory device 206 from the host 202 to execute the received update 220. As used herein, the term “execute an/the update” refers to the memory device 206 making the update 220 available to the device monitored by the host 202. The memory 216 may validate the update 220 and copy it to a different portion of the memory array 201 to make it available to the device monitored by the host 202.

Specifically, the circuitry 210 can generate, in response to receiving a signal, the expected signature and compare the expected signature to the received signature as part of an operation to check the validity of the received update 220. Because the memory provided a freshness value to the host 202 to calculate the signature to transmit to the memory with the update 220, the memory 216 should generate the same value as the expected signature. In other words, the hash of the received signature stored in the signature register 218, and the hash of the expected signature generated by the memory 216 when the memory 216 is to validate the update 220, are the same when the update 220 is determined to be authentic (e.g., valid).

In contrast, the hash of the received signature stored in the signature register 218, and the hash of the expected signature generated by the memory 216, when the memory 216 is to validate the update 220, are different when the update 220 is determined to be invalid. An invalid update may be an indication that the update was inadvertently pushed to the device and/or a hacking event was attempted. In either instance, the memory device 206 can notify the host and discard the update 220.

The expected signature is a cryptographic hash of the content stored in the memory array 201, which can be updated, altered, configured, an/or otherwise changed by the data included in the update received from the host 202. However, in these examples herein, the memory array may store the update for validation as opposed to executing the update on the memory device 206 itself. In some examples, the expected signature can comprise, for instance, a SHA-256 cryptographic hash. Further, the cryptographic hash of the data (e.g., the update 220) stored in memory array 201, and the cryptographic hash of the of the received signature, can each respectively comprise 256 bytes of data.

The cryptographic hash of the expected signature for the update 220 stored in memory array 201 can be generated (e.g., calculated), for example, by circuitry 210. In such an example, the cryptographic hash of the expected signature of the update 220 stored can be internally generated by memory device 206 without having external data moving on interface 204. As an additional example, the cryptographic hash of the received signature stored in the signature register 218 and associated with the update 220 can be communicated from an external entity (e.g., the host 202). For instance, host 202 can generate the cryptographic hash of the received signature associated with the update 220 stored in memory array 201 and send the generated cryptographic hash of the received signature to memory device 206 (e.g., circuitry 210 can receive the cryptographic hash of the received signature associated with the update 220 stored in memory array 201 from host 202).

The expected signature associated with the update 220 can be generated (e.g., calculated), for example, by circuitry 210 based on (e.g., responsive to) an external command, such as a command (e.g., signal) received from host 202. For instance, the expected signature can be generated using symmetric or asymmetric cryptography. The expected signature may include a freshness value in the form a value from a monotonic counter (which should match the freshness value provided to the host 202 to generate the signature received in association with the update 220). For example, host 202 can generate the signature, and send (e.g. provide) the generated signature to memory device 206 (e.g., circuitry 210 can receive the signature from host 202).

The freshness value can change with each update 220 received from the host 202. Accordingly, the freshness value may be used to validate that the incoming update 220 is a valid update. This is because the freshness value is used to calculate the signature associated with the update 220, as such, the host 202 uses the requested freshness value to generate the signature for the update 220. The update 220 is verified to be valid when the received signature indicates that the incoming update 220 is related to the host 202 because the host 202 has the correct freshness value. Thus, because the freshness value can be used to calculate the signature, the signature can be different with each incoming update 220.

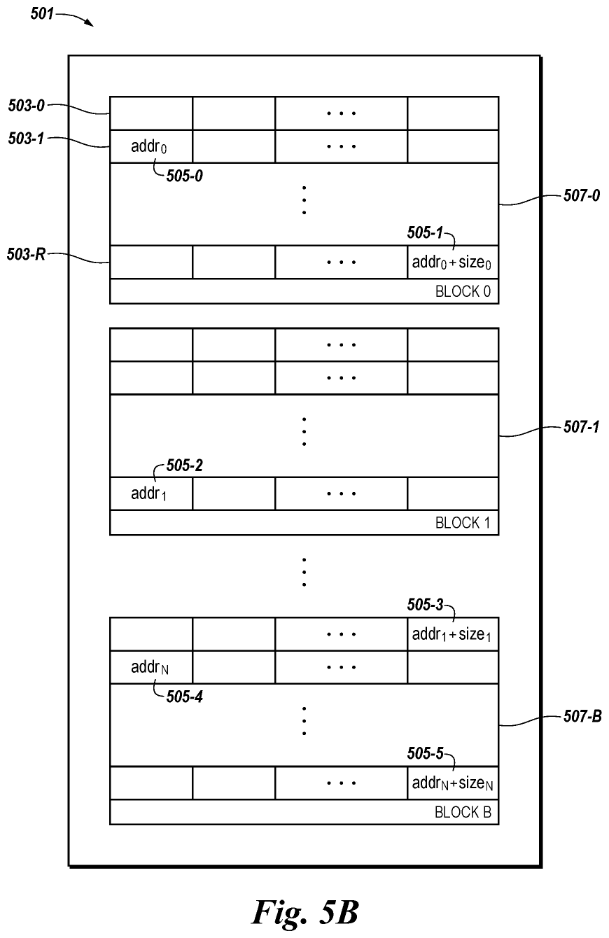

As mentioned, the signature can be, for instance, a digital signature generated using asymmetric cryptography (e.g., based on a public and/or private key), and can comprise, for instance, an elliptical curve digital signature. As an additional example, the signature can be generated using symmetric cryptography (e.g., based on a unique secret key shared between host 202 and memory device 206). The secret key can be exchanged by using any asymmetric protocol (e.g., the Diffie-Hellman protocol). In other examples, the key may be shared with the host 202 in a secure environment (e.g., factory production, secure manufacturing, etc.). The generation and validation of the secret key is discussed further in connection with FIGS. 6-11.

As shown in FIG. 2, the update 220, as well as the received signature associated with the update 220, can be stored in memory array 201. For example, the update 220 can be stored in a portion of memory array 201 that is inaccessible to a user of memory device 206, a device monitored by the host 202, and/or host 202 (e.g., in a “hidden” region of memory array 201). Storing the update 220 in memory array 201 until it is validated by the memory 216 can prevent a fraudulent or inadvertent update from executing on a device monitored by the host 202.

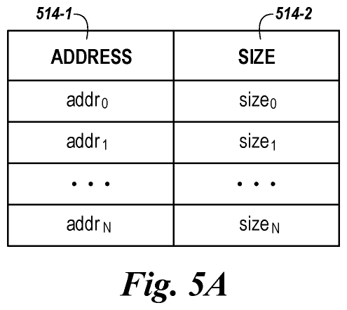

In an embodiment, memory array 201 (e.g., a subset of memory array 201, or the whole array 201) can be a secure array (e.g., an area of memory 216 to be kept under control). FIG. 2 illustrates a pair of registers 214-1 and 214-2 although embodiments are not so limited, and one or more registers and/or one or more pairs of registers could be used. For example, the e.g., data (e.g., update 220) stored in memory array 201 can include sensitive (e.g., non-user) data, such as device firmware and/or code to be executed for sensitive applications. In such an embodiment, a pair of non-volatile registers can be used to define the secure array. For example, in the embodiment illustrated in FIG. 2, circuitry 210 includes registers 214-1 and 214-2 that can be used to define the secure array. For instance, register 214-1 can define the address (e.g., the starting LBA of the data) of the secure array, and register 214-2 can define the size (e.g., the ending LBA of the data) of the secure array. An example of such registers, and their use in defining a secure array, will be further described herein (e.g., in connection with FIGS. 5A-5B).

Once the secure array has been defined, circuitry 210 can generate (e.g., calculate) a cryptographic hash associated with the secure array, which may be referred to herein as a golden hash, using authenticated and antireplay protected commands (e.g., so that only memory device 206 knows the golden hash, and only memory device 206 is capable of generating and updating it). The golden hash may be stored in inaccessible portion of memory array 201 (e.g., the same inaccessible portion in which update 220 is located) and can be used during the process of validating the update 220 of the secure array 201, as will be further described herein. In the preceding example, the golden hash value is the expected signature calculated to validate the update 220.

Specifically, the memory device 206 associated with the host 202 can receive an update 220 for a device associated with the host 202 and store the update 220 in the memory array 220. As mentioned, an update 220 received from the host 202 includes a generated received signature associated with the update. For example, the memory device 206 can receive a signature associated with the update 220. The received signature includes a freshness value indicating that the update 220 is associated with the host 202 because the freshness value is exchanged between the memory device 206 and the host 202. The memory device 206 may validate the update 220.

For example, the memory device 206 can determine whether the update 220 is valid based on a comparison between the received signature and an expected signature (e.g., the golden hash). The received signature and the expected signature having the same value indicates that the update is valid; and the memory can copy the update 220 from the secure memory array 201 to a non-secure portion of the memory device 206 in response to the determination that the received signature and the expected signature are the same.

Copying the update 220 to another portion of the memory array may include copying the update 220 from a secure portion of the memory array 201 to a non-secure portion of the memory array 201. In some examples, the validated update 220 may be copied to a different secure portion of the memory array 201, or combinations of secure and non-secure portions of the memory 216. In any embodiment, copying the update 220 to another portion of the memory array 201 in response to the validation of the update 220 makes the update 220 available to the device monitored by the host 202. In this way, a device monitored by the host 202 may receive a validated over-the-air update without the need for additional computing components.

In some examples, the validation of an update 220 can be initiated by the host 202 transmitting a signal to the memory device 206. In other examples, the validation is initiated by the circuitry 210 sensing the update 220 has been received. For example, circuitry 210 can sense (e.g., read) the update 220 stored in memory array 201, and the received signature in the signature register 218. In response to the circuitry sensing the update 220, the circuitry can generate an expected signature (e.g., the golden hash) to validate the update 220, responsive to a powering (e.g., a powering on and/or powering up) of memory device 206. As such, a validation of the update 220 stored in memory array 201 can be initiated (e.g., automatically) upon the powering of memory device 206.

For example, in embodiments in which memory array 201 is a secure array, the golden hash previously described herein may be used to validate the update 220 stored in memory array 201. For example, the received signature hash (stored in signature register 218) received with the update 220 can be generated (e.g., calculated), and compared with the golden hash (e.g., the expected signature). If the comparison indicates the received signature stored in signature register 218 and the expected signature match, it can be determined that the secure array has not been altered, and therefore the data stored therein is valid. Further, it indicates that the update 220 is from the host 202, because the host 202 must have the correct freshness value to calculate a signature to match the expected signature (e.g., the golden hash). If, however, the comparison indicates the received signature and expected signature do not match, this may indicate that the update 220 stored in the secure array 201 has been changed (e.g., due to a hacker, a fault in the memory, and/or an unintentional action), and/or was transmitted from a fraudulent (e.g., an imposter) host, and this can be reported to host 202.

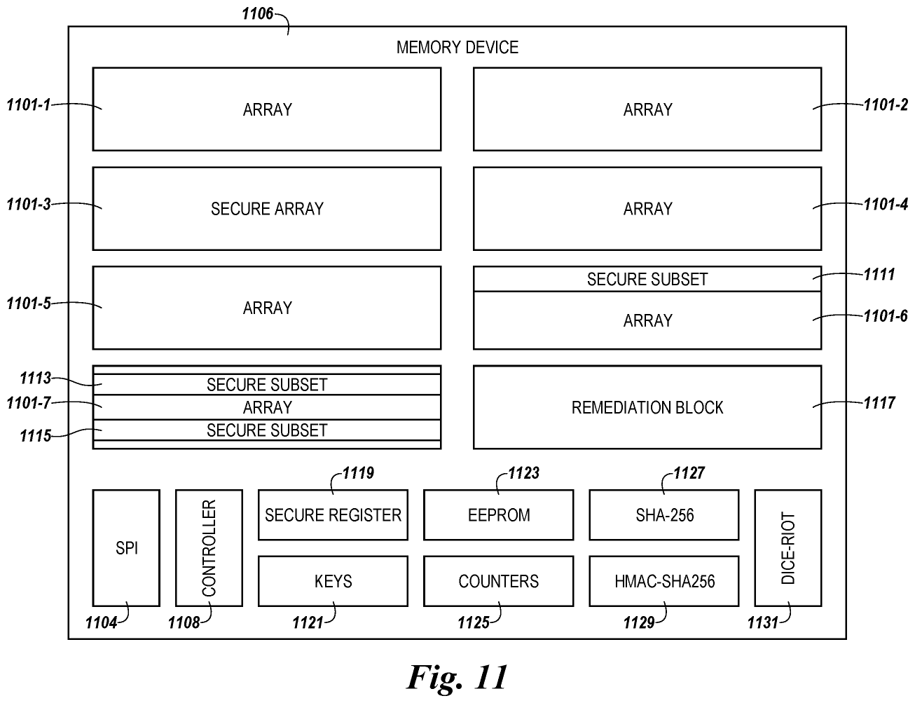

The embodiment illustrated in FIG. 2 can include additional circuitry, logic, and/or components not illustrated so as not to obscure embodiments of the present disclosure. For example, memory device 206 can include address circuitry to latch address signals provided over I/O connectors through I/O circuitry. Address signals can be received and decoded by a row decoder and a column decoder, to access memory array 201. Further, memory device 206 can include a main memory, such as, for instance, a DRAM or SDRAM, that is separate from and/or in addition to memory array 201. An example further illustrating additional circuitry, logic, and/or components of memory device 206 will be further described herein (e.g., in connection with FIG. 11).

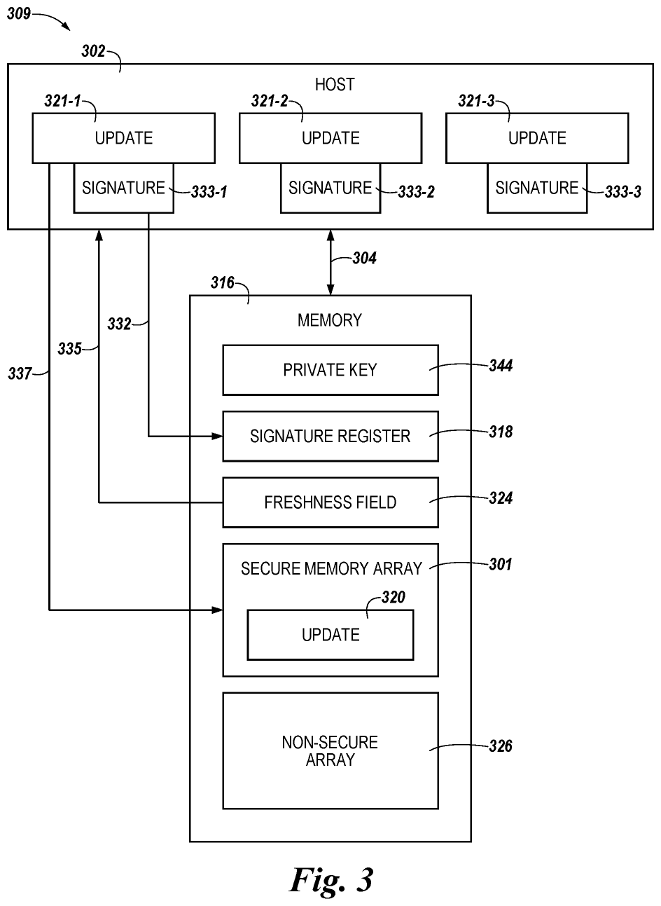

FIG. 3 illustrates an example system 309 for over-the-air update validation using an example memory device (e.g., memory device 206 previously described in connection with FIG. 2) in accordance with an embodiment of the present disclosure. FIG. 3 illustrates the system 309 including a host 302. As mentioned herein, the host 302 may monitor an individual device or multiple devices (not illustrated in FIG. 3) for needed updates to their respective firmware etc. As illustrated in FIG. 3, the host 302 may include individual and/or multiple updates (e.g., 321-1, 321-2, and 321-3) where each update includes a corresponding signature (e.g., 333-1, 333-2, and 333-3). Each update may be transmitted over-the-air to respective devices. For example, update 321-1 may be intended for a first type of an IoT device monitored by the host 302, update 321-2 may be intended for a second type of an IoT device monitored by the host 302, and 321-3 may be intended for a third type of an IoT device monitored by the host 302. Rather than types of IoT devices, updates 321-1, 321-2, and 321-3 may apply to categories, geographic regions, brands, age of the device, environmental factors, etc.

The memory 316 may participate in secure communication with the host 302 by exchanging public and private keys with the host 302. For example, the memory 316 can include a private key 344 which is associated with the host 302. The exchange of public and private keys may occur using a secure communication and/or a secure location (e.g., during manufacture etc.). The memory 316 may use the private key 344 to decrypt messages (e.g., updates 321-1, 321-2, and 321-3) from the host 302 and the memory 316 may verify the signatures 333-1, 333-2, and 333-3 associated with the updates 321 using a public key (not pictured) of the host 302. As mentioned, the generation and validation of the secret key (e.g., private key 344) is discussed further in connection with FIGS. 6-11.

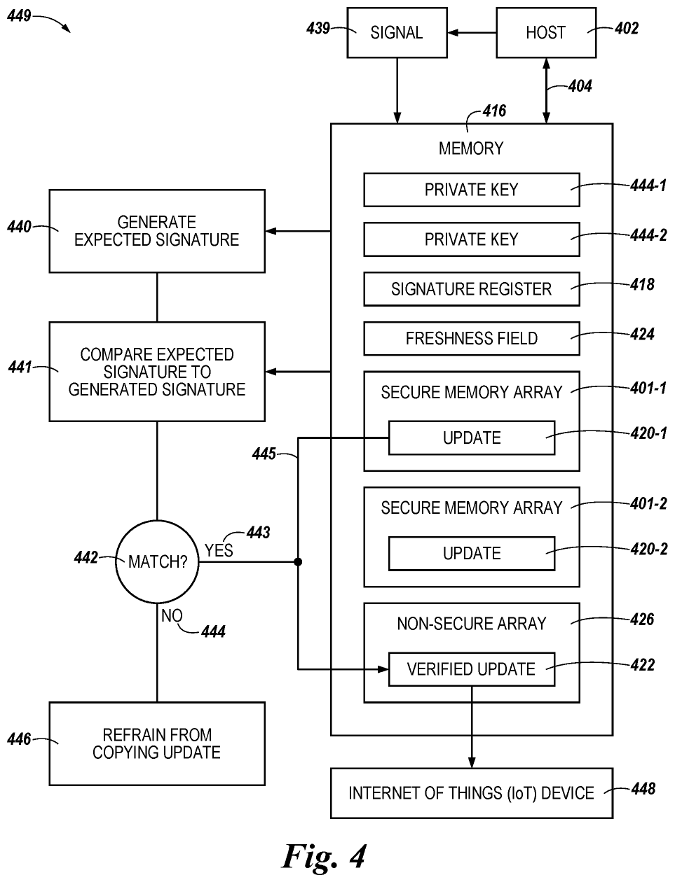

In some examples, the memory 316 may include multiple areas of the memory array (e.g., the secure memory array 301) to secure multiple updates (e.g., the updates 321-1, 321-2, and/or 321-3) at the same time, and/or during a period of time. The memory 316 can store multiple updates from an individual host (e.g., the host 302) and/or from multiple different hosts. In the instance where the memory 316 receives updates from multiple different hosts, the memory 316 may include a different private key (e.g., the private key 344) corresponding to each host. These embodiments are discussed further in connection with FIG. 4.

To provide validation for the updates 321, the host 302 may transmit the updates 321 to the memory 316, via an interface 304 (similar to interface 204 of FIG. 2). For example, the updates 321 are received over-the-air from the host 302 in response to the host 302 transmitting the updates (e.g., 321-1, 321-2, and 321-3) intended for multiple devices managed by the host 302. In this way, the memory 316 can validate a respective update for a respective device (e.g., or respective group of devices) managed by the host 302.

For example, circuitry (e.g., circuitry 210 described in connection with FIG. 2) and/or memory 316 can receive a signature 331-1 and an update 321-1 corresponding to the signature 333-1, from the host 302 where the update 321-1 is intended for a device monitored by the host 302. The circuitry can store (indicated by the arrow 337) the update 321-1 in the secure memory array 301 (e.g., a secure array) as update 320, and store (indicated by the arrow 332) the received signature 333-1 in a signature register 318.

As described previously, the received signature 331-1 is generated by the host 302 using a freshness value obtained from the memory 316. For example, to generate the signature 333-1 to correspond to the update 321-1, the host 302 may receive (indicated by arrow 335) a freshness value from a freshness field 324 (e.g., generated by a monotonic counter) of the memory 316. Because the freshness value changes with each update (e.g., 321-1, 321-2, and 321-3) each signature (e.g., 333-1, 333-2, and 333-3) will be different from one another. Thus, signature 333-1 is different from 333-2, which is different from 333-3. Further, because the host 302 obtains the freshness value from the memory 316, only the memory 316 and the host 302 can generate the same signatures, thus verifying that the update is not from an imposter when the received signature 333-1 and the expected signature (described in further detail in connection with FIG. 4) are the same.

For example, the circuitry can generate an expected signature to verify the update 320, where the update 320 is verified when the expected signature and received signature 333-1 are the same. As mentioned herein, in some examples, the verification process may be initiated when the memory 316 is powered on. In other examples, the circuitry may receive a command from the host 302 to read the signature 333-1, and generate the expected signature (e.g., the golden hash) where the expected signature is a hash of the secure array (e.g., secure memory array 301) that is storing the update 320 associated with the received signature 333-1.

In response to verifying the update 320 by determining that the received signature 333-1 and the generated expected signature are the same, the circuitry can make the update 320 available to the device it is intended to update. For example, the circuitry can copy the update 320 to a non-secure array 326 (e.g., a non-secure portion of the secure memory array 301) of the memory 316 when the update 320 is verified. In this way, the an over-the-air update 320 can be verified, and a device (and/or multiple devices) monitored by the host 302 can retrieve the update 320 from the non-secure array 326 and update their respective firmware regardless of the sophistication of the device. The methods and configurations described in connection with FIG. 3 can be applied to update 321-2, associated with signature 333-2, and update 321-3 associated with signature 333-3.

FIG. 4 illustrates an example flow diagram 449 for over-the-air update validation using an example memory device (e.g., memory 416) in accordance with an embodiment of the present disclosure. The flow diagram 449 illustrates an example memory 416 including private keys 444-1, and 444-2, a signature register 418, a freshness field 424, secure memory arrays 401-1 and 401-2 (e.g., the memory array 201 and/or a portion of the memory array 201 of FIG. 2), and a non-secure array 426. FIG. 4 illustrates an update 420-1 stored inside the secure memory array 401-1 after having been received as an update from the host 402 (e.g., the update 321-1 described in connection with FIG. 3). Secure memory arrays 401-1 and 401-2 are defined by registers (e.g., registers 214-1 and 214-2 discussed in connection with FIG. 2). FIG. 4 illustrates an update 420-2 stored inside the secure memory array 401-2 after having been received as an update from the host 402 (e.g., the update 321-2 described in connection with FIG. 3). Further, FIG. 4 illustrates a verified update 422 (which can be update 420-1 and/or update 420-2 post verification) stored in the non-secure array 426, where the verified update 422 indicates a validated update, as will be described in embodiments in connection with FIG. 4.

Although not illustrated in FIG. 4 as to not obscure examples of the disclosure, the host 402 may include updates (e.g., updates 321-1, 321-2, and 321-3 discussed in connection with FIG. 3) with respective signatures (e.g., 333-1, 333-2, and 333-3 discussed in connection with FIG. 3). The host 402 is communicatively coupled to the memory 416 via interface 404. The host 402 may monitor individual and/or multiple devices such as IoT device 448. Although an individual device 448 is illustrated in FIG. 4, multiple devices may be monitored by the host 402.

Although illustrated as including an individual host 402 the memory 416 may receive updates 420-1, 420-2 from multiple hosts (e.g., host 402). In a multi-host embodiment, the memory 416 may include one or more private keys (e.g., 444-1, and 444-2) where each private key can be associated with a particular host. For example, a first host (e.g., the host 416) may securely communicate with the memory 416 using the private key 444-1, and a second host (not illustrated) may securely communicate with the memory 416 using the private key 444-2).

For the purposes of ease of illustration, an individual host 402 is illustrated. In some examples, the host 402 may provide multiple updates (e.g., the updates 321-1, 321-2, and 321-3 associated with FIG. 3), which may be received by the memory 416 and stored in a secure memory array for validation. For example, the host 402 may provide an over-the-air first update (e.g., update 321-1 of FIG. 3) to be stored in the secure memory array 401-1 as update 420-1, and a second update (e.g., 321-2 of FIG. 3) to be stored in secure memory array 401-2 as update 420-2. Using the methods described herein, the memory 416 can provide over-the-air update validation for multiple updates (e.g., the updates 420-1 and 420-2) and/or an individual update.

The host 402 may be associated with the memory 416 such that the memory 416 can perform over-the-air update validation for the devices (e.g., the IoT device 448) monitored by the host 402. For example, receiving, by a memory device 416, a signature (e.g., 333-1) and an update (321-1) corresponding to the signature, from a host 402, where the update is for an IoT device 448 monitored by the host 402. In this example, receiving the signature from the host 402 further comprises the memory 416 transmitting, in response to a signal 439 received from the host 402, a freshness value from the freshness field 424 to the host 402. Specifically, at 439 via a signal (e.g., a request and/or data transmission), the host 402 may request a freshness value from the memory 416 such that a signature corresponding to the update to be verified can generated. The update 420-1 received from the host 402 corresponding to the IoT device 448 can be stored in the secure array 401-1 and securely validated by the memory 416.

For example, storing, by the memory 416, the update 420-1 in the secure memory array 401-1 and the received signature in the signature register 418 prevents the received but not validated update 420-1 from being available to the IoT device 448. The memory 416 can then compare the received signature stored in the signature register 418 to a generated expected signature (e.g., the golden hash). For example, at 440, generating, by the memory 416, the expected signature in response to receiving a command from the host 402 to execute the received update 420-1. In other words, comparing, at 441, by the memory 416, an expected signature (e.g., the golden hash) to the received signature (stored in signature register 418), where the expected signature is generated to verify the update 420-1. In some examples, the expected signature and the received signature do not match, which can indicate that the update 420-1 is incorrect, fraudulent, malicious, and/or otherwise unauthorized.

For example, at 442, the memory 416 may determine that the expected signature and the received signature do not match, (e.g., “NO” at 444). In this example, at 446, the memory 416 can refrain from copying the update 420-1 to a location outside of the secure memory array 401-1. In other words, because the update 420-1 is stored in a secure memory array 401-1 defined by registers (e.g., registers 214-1 and 214-2 discussed in connection with FIG. 2), the update 420-1 is secured from other users, devices, and/or hosts. Thus, the potentially corrupt update 420-1 can be removed from the memory 416 without damaging the IoT device 448 and/or the host 402. In other examples, the expected signature and the received signature match, indicating that the update 420-1 is from the host 402 and the update is verified.

For example, at 442, the memory 416 may determine that the expected signature and the received signature do match, (e.g., “YES” at 443). In this example, indicated by the arrow 445, the memory 416 can copy the update 420-1 to a location outside of the secure memory array 401-1 (e.g., the copy is verified update 422 in a non-secure array 426). For example, copying, by the memory 416, the update 420-1 from the secure memory array 401-1 of the memory 416 to a non-secure portion of the array 426 in response to the update 420-1 being verified and becoming the verified update 422, where the verified update 422 is available to the IoT device 448 when the update 420-1 is copied (becoming the verified update 422). In other words, because the verified update 422 is stored in a non-secure array 426, the verified update 422 is available to users, devices, and/or hosts. Further, in some examples, the memory 416 can transmit the verified update 422 to devices monitored by the host 402 that were intended to receive the over-the-air update.

The methods described herein in connection with FIG. 4 can be applied to multiple updates. For example, the method and examples, of over-the-air update validation as applied to the update 420-1 can be applied to the update 420-2 stored in the secure memory array 401-2.

FIG. 5A illustrates an example of a pair of registers 514-1 and 514-2 used to define a secure memory array in accordance with an embodiment of the present disclosure, and FIG. 5B illustrates a diagram of a portion of a memory array 501 that includes a secure memory array defined using registers 514-1 and 514-2 in accordance with an embodiment of the present disclosure. Registers 514-1 and 514-2 can be, for instance, registers 214-1 and 214-2, respectively, previously described in connection with FIG. 2, and secure memory array 501 can be, for instance, memory array 201 previously described in connection with FIG. 2. For instance, as shown in FIG. 5B, secure memory array 501 can include a number of physical blocks 507-0, 507-1, . . . , 507-B of memory cells, each including a number of physical rows 503-0, 503-1, . . . , 503-R having a number of sectors of memory cells, in a manner analogous to memory array 101 previously described in connection with FIG. 1.

As shown in FIG. 5A, register 514-1 can define addresses of the secure array (e.g., the addresses of different portions of the secure array), and register 514-2 can define sizes of the secure array (e.g., the sizes of the different portions of the secure array). The addresses of the secure array defined by register 514-1 can correspond to, for instance, starting points (e.g., starting LBAs) of the secure array (e.g., the starting points of the different portions of the secure array), and the sizes of the secure array defined by register 514-2 can correspond to, for instance, ending points (e.g., ending LBAs) of the secure array (e.g., the ending points of the different portions of the secure array).

For example, as shown in FIG. 5A, registers 514-1 and 514-2 can define N pairs of values, with each respective pair comprising an address value (e.g., addr) defined by register 514-1 and a size value (e.g., size) defined by register 514-2. For instance, in the example illustrated in FIG. 5A, Pair₀ comprises address value addr₀ and size value size₀ (e.g., Pair₀=[addr₀, size₀]), Pair₁ comprises address value addr₁ and size value size₁ (e.g., Pair₁=[addr₁, size₁]), and so on, with Pair_{N} comprising address value addr_{N} and size value size_{N} (e.g., Pair_{N}=[addr_{N}, size_{N}]). The address value of a pair can correspond to a starting point (e.g., starting LBA) of a portion of the secure array, and the sum of the address value and the size value of that pair can correspond to the ending point (e.g., ending LBA) of that portion of the secure array. As such, the entire secure array (e.g., the portions that comprise the entire secure array) can be given by: [addr₀, addr₀+size₀] ∪ [addr₁, addr₁+size₁] ∪ . . . ∪ [addr_{N}, addr_{N}+size_{N}].

The first pair whose size value defined by register 514-2 is zero can stop the definition of the secure array. For instance, in the example illustrated in FIG. 5A, if the size value of Pair₂ is zero, then the secure array would be given by: [addr₀, addr₀+size₀] ∪ [addr₁, addr₁+size₁].

An example of a secure array defined by registers 514-1 and 514-2 (e.g., with all size values defined by register 514-2 as non-zero) is illustrated in FIG. 5B. For instance, as shown in FIG. 5B, the address (e.g., LBA) associated with sector 505-0 of memory array 501 is addr₀, the address associated with sector 505-1 of memory array 501 is addr₀+size₀, the address associated with sector 505-2 of memory array 501 is addr₁, the address associated with sector 505-3 of memory array 501 is addr₁+size₁, the address associated with sector 505-4 of memory array 501 is addr_{N}, and the address associated with sector 505-5 of memory array 501 is addr_{N}+size_{N}. As such, the secure array comprises sectors (e.g., the data stored in sectors) 505-0 through 505-1, sectors 505-2 through 505-3, and 505-4 through 505-5. However, the sectors of memory array 501 that are before sector 505-0, and sectors 505-1 through 505-2 of memory array 501, are not part of the secure array (e.g., the secure array comprises a subset of array 501).

FIG. 6 is a block diagram of an example system including a host 602 and a memory device 606 in accordance with an embodiment of the present disclosure. Host 602 and memory device 606 can be, for example, host 202 and memory device 206, respectively, previously described in connection with FIG. 2.

A computing device can boot in stages using layers, with each layer authenticating and loading a subsequent layer and providing increasingly sophisticated runtime services at each layer. A layer can be served by a prior layer and serve a subsequent layer, thereby creating an interconnected web of the layers that builds upon lower layers and serves higher order layers. As is illustrated in FIG. 6, Layer 0 (“L₀”) 651 and Layer 1 (“L₁”) 653 are within the host. Layer 0 651 can provide a Firmware Derivative Secret (FDS) key 652 to Layer 1 653. The FDS key 652 can describe the identity of code of Layer 1 653 and other security relevant data. In an example, a particular protocol (such as robust internet of things (RIOT) core protocol) can use the FDS 652 to validate code of Layer 1 653 that it loads. In an example, the particular protocol can include a device identification composition engine (DICE) and/or the RIOT core protocol. As an example, an FDS can include Layer 1 firmware image itself, a manifest that cryptographically identifies authorized Layer 1 firmware, a firmware version number of signed firmware in the context of a secure boot implementation, and/or security-critical configuration settings for the device. A device secret 658 can be used to create the FDS 652 and be stored in memory associated with the host 602.

The host can transmit data, as illustrated by arrow 654, to the memory device 606. The transmitted data can include an external identification that is public, a certificate (e.g., an external identification certificate), and/or an external public key. Layer 2 (“L₂”) 655 of the memory device 606 can receive the transmitted data, and execute the data in operations of the operating system (“OS”) 657 and on a first application 659-1 and a second application 659-2.

In an example operation, the host 602 can read the device secret 658, hash an identity of Layer 1 653, and perform a calculation including:

K_{L1}=KDF [Fs(s), Hash (“immutable information”)]

where K_{L1} is an external public key, KDF (e.g., KDF defined in the National Institute of Standards and Technology (NIST) Special Publication 800-108) is a key derivation function (e.g., HMAC-SHA256), and Fs(s) is the device secret 658. FDS 652 can be determined by performing:

FDS=HMAC-SHA256 [Fs(s), SHA256(“immutable information”)]

Likewise, the memory device 606 can transmit data, as illustrated by arrow 656, to the host 602.

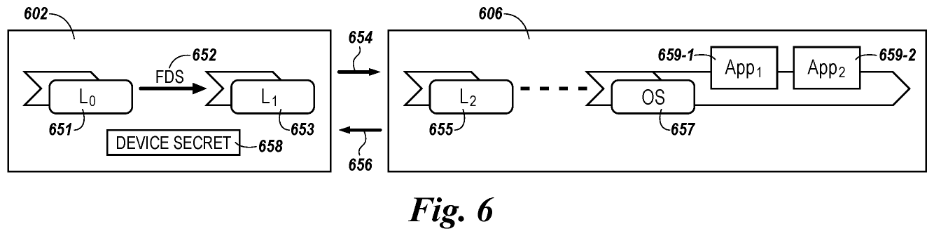

FIG. 7 is a block diagram of an example process to determine a number of parameters in accordance with an embodiment of the present disclosure. FIG. 7 is an example of a determination of the parameters including the external public identification, the external certificate, and the external public key that are then sent, indicated by arrow 754, to Layer 2 (e.g., Layer 2 655) of a memory device (e.g., 606 in FIG. 6). Layer 0 (“L₀”) 751 in FIG. 7 corresponds to Layer 0 651 in FIG. 6 and likewise FDS 752 corresponds to FDS 652, Layer 1 753 corresponds to Layer 1 653, and arrows 754 and 756 correspond to arrows 654 and 656, respectively.

The FDS 752 from Layer 0 751 is sent to Layer 1 753 and used by an asymmetric ID generator 761 to generate a public identification (“ID_{lk public}”) 765 and a private identification 767. In the abbreviated “ID_{lk public},” the “lk” indicates Layer k (in this example Layer 1), and the “public” indicates that the identification is openly shared. The public identification 765 is illustrated as shared by the arrow extending to the right and outside of Layer 1 753 of the host. The generated private identification 767 is used as a key input into an encryptor 773. The encryptor 773 can be any processor, computing device, etc. used to encrypt data.

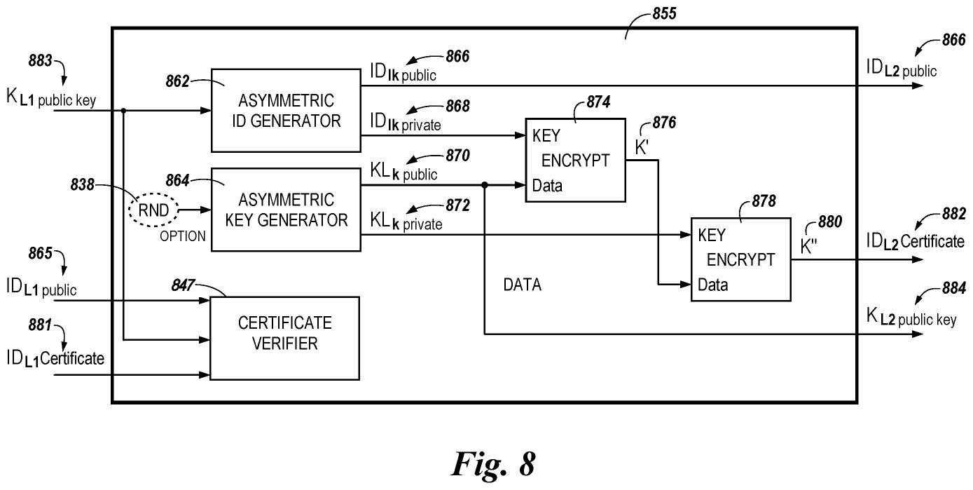

Layer 1 753 of a host can include an asymmetric key generator 763. In at least one example, a random number generator (RND) 736 can optionally input a random number into the asymmetric key generator 763. The asymmetric key generator 763 can generate a public key (“K_{Lk public}”) 769 (referred to as an external public key) and a private key (“K_{LK private}”) 771 (referred to as an external private key) associated with a host such as host 602 in FIG. 6. The external public key 769 can be an input (as “data”) into the encryptor 773. The encryptor 773 can generate a result K′775 using the inputs of the external private identification 767 and the external public key 769. The external private key 771 and the result K′775 can be input into an additional encryptor 777, resulting in output K″ 779. The output K″ 779 is the external certificate (“ID_{L1} certificate”) 781 transmitted to the Layer 2 (655 of FIG. 6). The external certificate 781 can provide an ability to verify and/or authenticate an origin of data sent from a device. As an example, data sent from the host can be associated with an identity of the host by verifying the certificate, as will be described further in association with FIG. 9. Further, the external public key (“K_{L1 public key}”) 783 can be transmitted to Layer 2. Therefore, the public identification 765, the certificate 781, and the external public key 783 of a host can be transmitted to Layer 2 of a memory device.

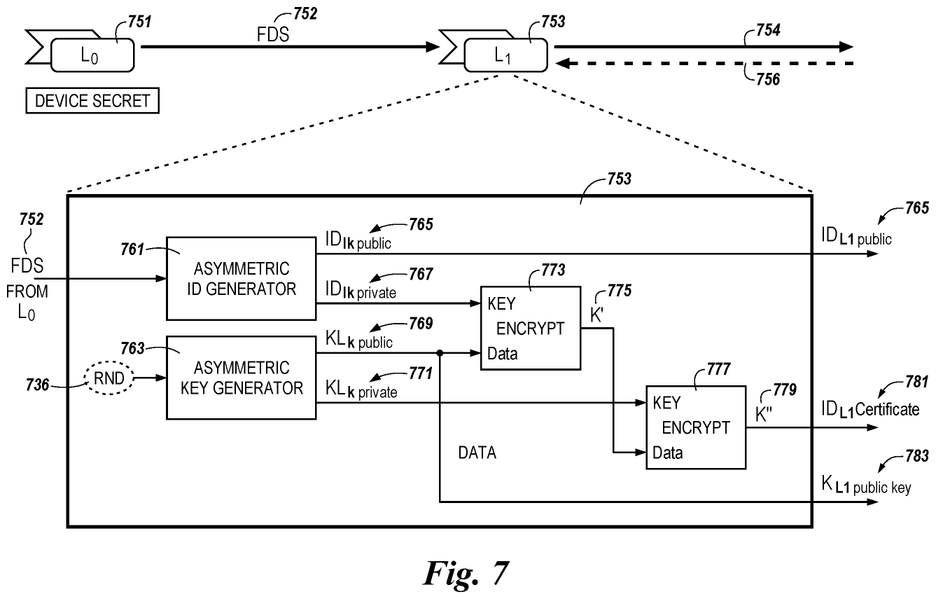

FIG. 8 is a block diagram of an example process to determine a number of parameters in accordance with an embodiment of the present disclosure. FIG. 8 illustrates a Layer 2 855 of a memory device (e.g., memory device 606 in FIG. 6) generating a device identification (“ID_{L2} public”) 866, a device certificate (“ID_{L2} Certificate”) 882, and a device public key (“K_{L2 public key}”) 884.

The external public key (“K_{L1 public key}”) 883 transmitted from Layer 1 of the host to Layer 2 855 of a memory device, as described in FIG. 7, is used by an asymmetric ID generator 862 of the memory device to generate a public identification (“ID_{lk public}”) 866 and a private identification 868 of the memory device. In the abbreviated “ID_{lk public},” the “lk” indicates Layer k (in this example Layer 2), and the “public” indicates that the identification is openly shared. The public identification 866 is illustrated as shared by the arrow extending to the right and outside Layer 2 855. The generated private identification 868 is used as a key input into an encryptor 874.

As shown in FIG. 8, the external certificate 881 and external identification 865, along with the external public key 883, are used by a certificate verifier 847. The certificate verifier 847 can verify the external certificate 881 received from a host (e.g., host 602), and determine, in response to the external certificate 881 being verified or not being verified, whether to accept or discard data received from the host. Further details of verifying the external certificate 881 is described in connection with FIG. 9.

Layer 2 855 of the memory device can include an asymmetric key generator 864. In at least one example, a random number generator (RND) 838 can optionally input a random number into the asymmetric key generator 864. The asymmetric key generator 864 can generate a public key (“K_{Lk public}”) 870 (referred to as a device public key) and a private key (“K_{LK private}”) 872 (referred to as a device private key) associated with a memory device such as memory device 606 in FIG. 6. The device public key 870 can be an input (as “data”) into the encryptor 874. The encryptor 874 can generate a result K′ 876 using the inputs of the device private identification 868 and the device public key 870. The device private key 872 and the result K′ 876 can be input into an additional encryptor 878, resulting in output K″ 880. The output K″ 880 is the device certificate (“ID_{L2} certificate”) 882 transmitted back to the Layer 1 (653 of FIG. 6). The device certificate 882 can provide an ability to verify and/or authenticate an origin of data sent from a device. As an example, data sent from the memory device can be associated with an identity of the memory device by verifying the certificate, as will be described further in association with FIG. 9. Further, the device public key (“K_{L2 public key}”) 884 can be transmitted to Layer 1. Therefore, the public identification 866, the certificate 882, and the device public key 884 of the memory device can be transmitted to Layer 1 of a host.

In an example, in response to a host receiving a public key from a memory device, the host can encrypt data to be sent to the memory device using the device public key. Vice versa, the memory device can encrypt data to be sent to the host using the external public key. In response to the memory device receiving data encrypted using the device public key, the memory device can decrypt the data using its own device private key. Likewise, in response to the host receiving data encrypted using the external public key, the host can decrypt the data using its own external private key. As the device private key is not shared with another device outside the memory device and the external private key is not shared with another device outside the host, the data sent to the memory device and the host remains secure.

FIG. 9 is a block diagram of an example process to verify a certificate in accordance with an embodiment of the present disclosure. In the illustrated example of FIG. 9, a public key 983, a certificate 981, and a public identification 965 is provided from a host (e.g., from Layer 1 653 of host 602 in FIG. 6). The data of the certificate 981 and the external public key 983 can be used as inputs into a decryptor 985. The decryptor 985 can be any processor, computing device, etc used to decrypt data. The result of the decryption of the certificate 981 and the external public key 983 can be used as an input into a secondary decryptor 987 along with the public identification, result in an output. The external public key 983 and the output from the decryptor 987 can indicate, as illustrated at 989, whether the certificate is verified by a comparison, resulting in a yes or no 991 as an output. In response to the certificate being verified, data received from the device being verified can be accepted, decrypted, and processed. In response to the certificate not being verified, data received from the device being verified can be discarded, removed, and/or ignored. In this way, nefarious devices sending nefarious data can be detected and avoided. As an example, a hacker sending data to be processed can be identified and the hacking data not processed.

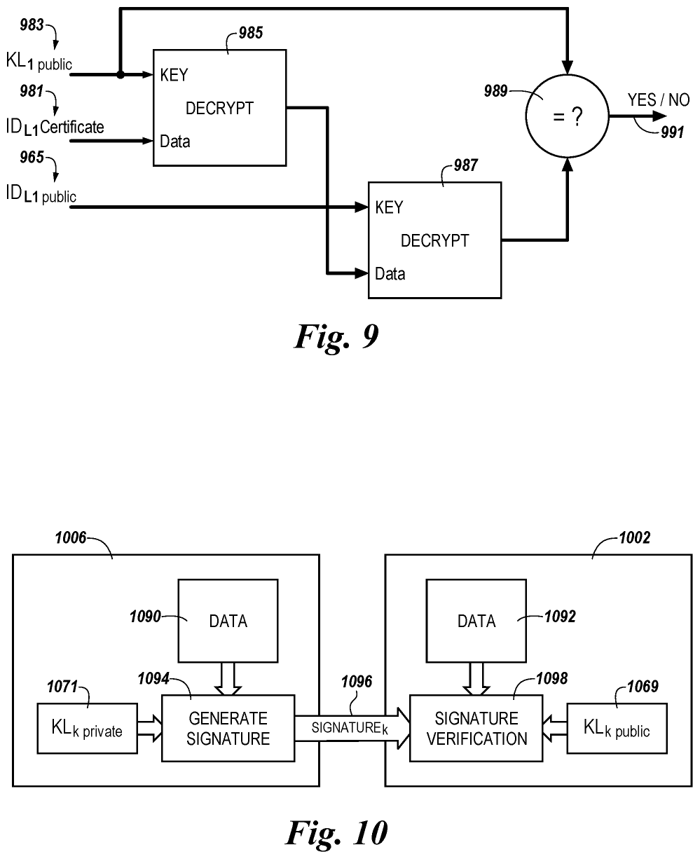

FIG. 10 is a block diagram of an example process to verify a signature in accordance with an embodiment of the present disclosure. In the instance where a device is sending data that may be verified in order to avoid subsequent repudiation, a signature can be generated and sent with data. As an example, a first device may make a request of a second device and once the second device performs the request, the first device may indicate that the first device never made such a request. An anti-repudiation approach, such as using a signature, can avoid repudiation by the first device and insure that the second device can perform the requested task without subsequent difficulty.

A memory device 1006 (such as memory device 206 in FIG. 2) can send data 1090 to a host (such as host 202 in FIG. 2). The memory device 1006 can generate, at 1094, a signature 1096 using a device private key 1071. The signature 1096 can be transmitted to the host 1002. The host 1002 can verify, at 1098, the signature using data 1092 and the external public key 1069 previously received. In this way, the signature is generated using a private key and verified using a public key. In this way, the private key used to generate a unique signature can remain private to the device sending the signature while allowing the receiving device to be able to decrypt the signature using the public key of the sending device for verification. This is in contrast to encryption/decryption of the data, which is encrypted by the sending device using the public key of the receiving device and decrypted by the receiving device using the private key of the receiver. In at least one example, the device can verify the digital signature by using an internal cryptography process (e.g., Elliptical Curve Digital signature (ECDSA) or a similar process.

FIG. 11 is a block diagram of an example memory device 1106 in accordance with an embodiment of the present disclosure. Memory device 1106 can be, for example, memory device 206 previously described in connection with FIG. 2.

As shown in FIG. 11, memory device 1106 can include a number of memory arrays 1101-1 through 1101-7. Memory arrays 1101-1 through 1101-7 can be analogous to memory array 101 previously described in connection with FIG. 1. Further, in the example illustrated in FIG. 11, memory array 1101-3 is a secure array, subset 1111 of memory array 1101-6 comprises a secure array, and subsets 1113 and 1115 of memory array 1101-7 comprise a secure array. Subsets 1111, 1113, and 1115 can each include, for instance, 4 kilobytes of data. However, embodiments of the present disclosure are not limited to a particular number or arrangement of memory arrays or secure arrays.

As shown in FIG. 11, memory device 1106 can include a remediation (e.g., recovery) block 1117. Remediation block 1117 can be used as a source of data in case of errors (e.g., mismatches) that may occur during operation of memory device 1106. Remediation block 1117 may be outside of the area of memory device 1106 that is addressable by a host.

As shown in FIG. 11, memory device 1106 can include a serial peripheral interface (SPI) 1104 and a controller 1108. Memory device 1106 can use SPI 1104 and controller 1108 to communicate with a host and memory arrays 1101-1 through 1101-7, as previously described herein (e.g., in connection with FIG. 2).

As shown in FIG. 11, memory device 1106 can include a secure register 1119 for managing the security of memory device 1106. For example, secure register 1119 can configure, and communicate externally, to an application controller. Further, secure register 1119 may be modifiable by an authentication command.

As shown in FIG. 11, memory device 1106 can include keys 1121. For instance, memory device 1106 can include eight different slots to store keys such as root keys, DICE-RIOT keys, and/or other external session keys.

As shown in FIG. 11, memory device 1106 can include an electronically erasable programmable read-only memory (EEPROM) 1123. EEPROM 1123 can provide a secure non-volatile area available for a host, in which individual bytes of data can be erased and programmed.

As shown in FIG. 11, memory device 1106 can include counters (e.g., monotonic counters) 1125. Counters 1125 can be used as an anti-replay mechanism (e.g., freshness generator) for commands (e.g., to sign a command set or sequence) received from and/or sent to a host. For instance, memory device 1106 can include six different monotonic counters, two of which may be used by memory device 1106 for the authenticated commands, and four of which may be used by the host.

As shown in FIG. 11, memory device 1106 can include an SHA-256 cryptographic hash function 1127, and/or an HMAC-SHA256 cryptographic hash function 1129. SHA-256 and/or HMAC-SHA256 cryptographic hash functions 1127 and 1129 can be used by memory device 1106 to generate cryptographic hashes, such as, for instance, the cryptographic hashes of the update 220 previously described herein in connection with FIG. 2, and/or a golden hash used to validate the data stored in memory arrays 1101-1 through 1101-7 as previously described herein. Further, memory device 1106 can support L0 and L1 of DICE-RIOT 1131.

Although specific embodiments have been illustrated and described herein, those of ordinary skill in the art will appreciate that an arrangement calculated to achieve the same results can be substituted for the specific embodiments shown. This disclosure is intended to cover adaptations or variations of a number of embodiments of the present disclosure. It is to be understood that the above description has been made in an illustrative fashion, and not a restrictive one. Combination of the above embodiments, and other embodiments not specifically described herein will be apparent to those of ordinary skill in the art upon reviewing the above description. The scope of a number of embodiments of the present disclosure includes other applications in which the above structures and methods are used. Therefore, the scope of a number of embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a memory; and
circuitry associated with the memory, the circuitry configured to:
monitor the memory for receipt of over-the-air updates;
store a received update in a secure array of the memory;
receive a hash of a signature associated with the received update and store the hash of the received signature in a register of the memory;
receive an indication that the received update is authentic, wherein the indication includes a hash of an expected signature; and
take an action in response to the indication that the received update is authentic.

2. The apparatus of claim 1, wherein the circuitry is configured to generate the hash of the expected signature in response to a signal received by the memory from a host to execute the received update.

3. The apparatus of claim 1, wherein the update includes instructions to configure an internet of things (IoT) device monitored by a host associated with the memory.

4. The apparatus of claim 1, wherein the circuitry is further configured to:
generate, in response to receiving a signal, the hash of the expected signature; and
compare, in response to receiving the signal, the hash of the expected signature to the hash of the received signature as part of an operation to check the validity of the received update.

5. The apparatus of claim 4, wherein the hash of the received signature and the hash of the expected signature are different when the update is determined to be invalid.

6. The apparatus of claim 4, wherein the hash of the received signature and the hash of the expected signature are the same when the update is authentic.

7. The apparatus of claim 1, wherein the memory is associated with a host, and the host manages an internet of things (IoT) device.

8. The apparatus of claim 7 wherein the received update is transmitted over-the-air to the memory from the host.

9. The apparatus of claim 7, wherein the memory provides the received update to the IoT device when the received update is determined, by the memory, to be valid.

10. The apparatus of claim 1, wherein the action is to copy the received update from the secure array to a non-secure potion of the memory where the received update is accessible to a device monitored by a host.

11. The apparatus of claim 1, wherein the action is to copy the received update from the secure array to a different portion of the secure array of the memory where the received update is accessible to a device monitored by a host.

12. An apparatus, comprising:
a memory associated with a host; and
circuitry associated with the memory, the circuitry configured to:
receive an update associated with the host and store the update in a secure array of the memory;
receive a signature associated with the update, wherein the received signature includes a freshness value indicating that the update is associated with the host;
determine whether the update is valid based on a comparison between the received signature and an expected signature, wherein a difference between the received signature and the expected signature indicates that the update is invalid; and
copy the update from the secure array to a non-secure portion of the memory in response to the determination that the received signature and the expected signature are the same.

13. The apparatus of claim 12, wherein the memory validates the update for a device managed by the host.

14. The apparatus of claim 13, wherein the device accesses the validated update when the update is copied from the secure array to the non-secure portion of the memory.

15. The apparatus of claim 12, wherein the update is received over-the-air from the host in response to the host transmitting the update for multiple devices managed by the host.

16. The apparatus of claim 12, wherein the circuitry is further configured to provide the freshness value to the host when the host generates the received signature associated with the update.

17. A system, comprising:
a host;
a memory device associated with the host; and
circuitry configured to:
receive a signature and an update corresponding to the received signature from the host, wherein the update is for a device monitored by the host;
store the update corresponding to the device monitored by the host in a secure array of the memory device, and store the received signature in a signature register of the memory device;
generate an expected signature to verify the update, wherein the update is verified when the expected signature and the received signature are the same; and
copy the update to a non-secure portion of the memory device when the update is verified.

18. The system of claim 17, wherein the circuitry is further configured to:
receive a command from the host to read the signature; and
generate the expected signature, wherein the expected signature is a hash of the secure array that is storing the update associated with the received signature.

19. The system of claim 17, wherein the device monitored by the host is an internet of things (IoT) sensor.

20. A method, comprising:
receiving, by a memory device, a signature and an update corresponding to the signature, from a host, wherein the update is for an internet of things (IoT) device monitored by the host;
storing, by the memory device, the update in a secure array of the memory device and the received signature in a register of the memory device;
comparing, by the memory device, an expected signature to the received signature, wherein the expected signature is generated to verify the update; and
copying, by the memory device, the update from the secure array of the memory device to a non-secure portion of the memory device in response to the update being verified, wherein the update is available to the IoT device when the update is copied to the non-secure portion of the memory device.

21. The method of claim 20, wherein receiving the signature from the host further comprises the memory device transmitting, in response to a signal received from the host, a freshness value to the host.

22. The method of claim 20, wherein comparing the expected signature to the received signature further comprises generating a hash of the expected signature in response to receiving a command from the host to execute the received update.

23. The method of claim 20, wherein copying the update from the secure array of the memory device to the non-secure portion of the memory device further comprises transmitting the update to the IoT device for execution.

24. The method of claim 20, wherein the host is a manufacturer of the IoT device.
